(19) United States
(12) Patent Application Publication
(10) Pub. No.: US 2004/0099368 A1
(43) Pub. Date: May 27, 2004

(54) Transfer printing

(76) Inventors: Peter Alexander Leigh, Oxford (GB); Kevin Lorimer, Yarnton Kidlington (GB); Ronald Neil Butler, Oxfordshire (GB)

Correspondence Address: Quarles & Brady, 411 East Wisconsin Avenue, Milwaukee, WI, 53202-4497, US

(21) Appl. No.: 10/471,364

(22) PCT Filed: Dec. 21, 2001
(86) PCT No.: PCT/GB01/05718

(30) Foreign Application Priority Data
Mar. 15, 2001 (GB) 0106417.9

(51) Int. Cl. B44C 1/165; B41M 1/00; B32B 31/00

(52) U.S. Cl. 156/237; 156/230; 156/277; 156/240

(57) ABSTRACT

A process for preparing a printed substrate which comprises: (a) printing the desired pattern on to a release film, (b) adhering a substrate layer to the patterned side of the printed release film substrate, and (c) removing the release film, thereby producing a substrate bearing a print, the flatness of the surface of which corresponds to that of the film.

This invention relates to transfer printing.

Modern printed circuitry has developed contemporaneously with integrated circuit technology. In both of these areas the drive has been to smaller feature sizes while maintaining pattern definition and integrity. The finest patterns defined by screen-printing are of the order of 50 microns in the laboratory and about 200 microns commercially. Yet in integrated circuit production using lithography features sizes down to 1 micron are commonplace. The high quality of the silicon substrates with excellent flatness and thickness control are an essential requirement for lithography. A major limitation of screen-printing is the intrinsic roughness of the surface of the screen-printed pattern inherent in its production due to the high concentration of conductive fillers.

The aim of the present invention is to provide a system whereby features as small as 1 micron can be photolithographically defined onto a printed pattern using mix and match technology. The method has the potential of extending printing technology to greater integration with high definition photolithographic imaging while making it possible to use substrates other than silicon.

Present screen-printing technology for conductive materials employs screen-printing metal or carbon inks onto printed circuit board or polymer substrates. Alternatively screen-printing onto fully flexible polymer substrates about 100 microns thick is routinely employed. In all cases the top surface of the screen-printed surface has relatively poor topography compared with a feature defined by thin film technology. Typical roughness average values of such screen-printed features are near to 1 micron. This implies that peak-to-peak differences on the surface may be greater than 2 micron. Thus to image well defined geometrical fine features of 1 micron in size is extremely difficult, if not impossible. The present method aims to overcome this inherent problem and enables printing features with a surface roughness average of as little as 0.03 micron with parallelism and flatness thus enabling photolithography of fine 1-micron features to be successful.

According to the present invention there is provided a process for preparing a printed substrate which comprises:

(a) printing the desired pattern onto a release film,

(b) adhering a substrate layer to the patterned side of the printed release film, and

(c) removing the release film thereby producing a substrate bearing a print, the flatness of the surface of which corresponds to that of the film.

In accordance with a first embodiment the substrate layer is adhered by first (b′) applying a sealing layer over the printed pattern and then (b″) contacting the substrate with the patterned side of the printed release film so that the sealing layer adheres to the substrate.

It will be appreciated that the nature of the substrate is not critical although it should be dimensionally stable and a wide variety of materials can be employed including paper, metal foils and various polymeric substrates including PET (polyethylene terephthalate), PBT (polybutylene terephthalate) and PVC.

The release film will typically be 20-175 microns thick and should desirably be as flat as possible. Suitable films are those which can readily be separated from the ink or other material which is applied to it. Examples include olefinic polymers, such as polymers of ethylene and/or propylene, including polypropylene and high density polyethylene. Other materials include polyesters such as polyethylene terephthalate, preferably those which have been provided with either a siliconised or a non-siliconised release coating. Also polyfluorocarbon films such as PVF (such as Tedlar), PFA and FEP can also be used.

In accordance with the present invention, the first step in the process involves printing the desired material on to the release film. For example, if one is concerned with making carbon biosensors then a carbon ink will be printed on to the release film. Other types of printing materials include those intended for electronic circuits and for solar cells such as other electrically conductive inks, for example those based on nickel, silver, gold or platinum, for example interconnection materials or passivation materials or dielectrics. A variety of printing methods can be employed including ink jet printing, thermal transfer, lithographic or gravure printing but screen printing is preferred. The subsequent description will therefore refer to screen-printing although it is to be appreciated that other types of printing can be used instead.

Once the printed pattern has been applied to the release film, it is then typically dried and/or cured, for example in an oven, typically at about 90° C.; curing times will, of course, be dependent on the nature of the material but typically times of 30 minutes to 5 hours, for example 1 to 4 hours, more particularly about 2.5 hours, are generally suitable. The use of ambient drying inks and two-component reactive inks allow for room temperature curing.

In the first embodiment, in order to apply the sealing layer in step (b′) the release film is suitably mounted on a support, typically on a frame or bed e.g. of aluminium using adhesive tape or, for example, tensioned by roll-to-roll coating. The sealing layer can then be applied to the printed side of the film by, for example, spraying, roll coating, brushing or dip coating. Alternatively, printing can be used to apply the sealing layer. Suitable sealing materials include vinyl chloride polymers, acrylate polymers, for example methacrylate polymers, aromatic or aliphatic polyurethane resins or alkyd resins such as the Baxenden prepolymerised polyurethanes Trixene Sc7930 and Trixene Sc7913 which cure at 50° C. in 15 minutes. In general it will then be necessary to dry the sealing layer at ambient or elevated temperature, for example at 50° C. for one hour. The material is then ready to be transferred to the substrate.

In step (b″) in order that the sealing layer (with the pattern contained within it) can adhere to the substrate, it is generally necessary for a layer of an adhesive to be applied, generally to the substrate. Suitable adhesives for this purpose include thermoplastic adhesives, typically with a softening point of 60 to 150° C., for example, about 80° C. Such thermoplastic adhesives can then be laminated to the substrate using heat i.e. the adhesive is thermally activated. Alternatively, the adhesive can be one which is UV-curable in which case it can be cured during lamination using a UV source. Again, an aerobic curing adhesive can be used which will self cure on lamination. Yet again, two-component adhesives can be used which cure by chemical reaction with each other such as two component epoxy resin systems such as Araldite. Further pressure sensitive adhesives can be used that bond on contact.

Step (b″) is generally achieved by placing the release film, print surface down, on top of the substrate, and then, if using a thermoplastic adhesive, typically raising the temperature to cause the adhesive to fuse with the print surface, for example by hot pressing or laminating. On cooling, it is a simple matter to peel off the release film leaving the printed pattern now adhered to the substrate. In one embodiment, adherence can be achieved by passing the combination though a layer of heated rollers for example, heated nips or by using a laminating device such as Muro Photonex-325WI. Generally temperatures of 70 to 140° C., typically about 120° C., can be used, typically with speeds of 0.003 to 0.015 msec⁻¹, for example about 0.005 msec⁻¹.

It will be appreciated that once the release film has been removed in step (c) the top surface of the print is now that which was in contact with the release film.

Accordingly, the topography and flatness of this top surface corresponds to that of the release film used. This ensures that excellent topography and surface flatness can be achieved.

In a second embodiment of the process, the intended substrate can be injection moulded over the printed surface of the release film such that there is no need for a separate adhesive between the substrate and the printed side of the release film. Typically, such an arrangement can be carried out by indexing a ribbon of the printed film though a multi-cavity mould. Alternatively a polymerisable monomer is applied over the printed surface and then polymerised. Again no adhesive is needed. Suitable monomers include UV or thermally curable monomers or free radical curable monomers such as styrene, along with curable low temperature polyesters and epoxy resins. The monomers are suitably applied by spin coating. The adherent coating can also take the form of an adhesive such as an aerobic or UV curable adhesive such as a polyester or epoxy adhesive, which can be cured in a conventional manner. It will be appreciated that convention materials can be used to form the substrate layer in this way.

If the printed substrate is intended for the manufacture of a micro array carbon biosensor then it is necessary to complete the article by forming microelectrodes on the printed surface. This can be achieved generally by photolithography by applying a coating of photo resist, typically 0.3 to 10, for example 1 to 5, microns thick. Any of the usual techniques can be employed for this including spraying, spinning, dip-coating, screen-printing, air knife levelling or using a dry film resist in the necessary controlled environment. Then the resist coated substrate can be presented to a masked aligner with the necessary previously designed photo mask in place. In the particular case of our masked aligner a three inch (7.5 cm) diameter disk is cut from the substrate which matches the chuck of the aligner. Obviously, a range of substrate sizes can be employed. It should be mentioned that if the substrate layer is formed from an adhesive care needs to be taken to ensure that no solvent based interaction ocours between the layer and the adjacent photo-lith layer.

The desired fine geometry pattern is exposed through the photo mask to the resist in the usual manner using contact or proximity printing. After development, the desired pattern is visible using high powered magnification and can be used as microelectrodes for electrochemistry, or to fabricate the appropriate layer or the original printed design. For example, a layer of silicon ink can be printed using the process described above and then a photolithographic process can be used to dope, oxidise and provide metallised areas in the usual manner to produce simple silicon based devices. Alternatively a gold layer, for example, can be printed and a photolithographic process is used to etch the exposed gold away to leave a fine set of conducting pathways. Again a photolithographic resist can be applied to the release film, printing a patterned conductive layer onto this and removing excess by, for example, etching and then removing the resist layer.

In an alternative embodiment which provides additional benefits the dielectric photo polymer is applied to the transfer release film. This can then be imaged using lithography and then the micro array is subsequently printed in step (a). On removal of the transfer film in step (c) the array is of a “micro disk” structure.

In a modification of this procedure, the photo resist is applied to the transfer film followed by the printing of the carbon ink before the dielectric layer is imaged. This provides a flat imaging surface at the dielectric layer/transfer film interface and this can provide a more consistent release when the transfer film is removed as there are not dissimilar materials adjacent to the film.

The following Example further illustrates the present invention.

### EXAMPLE

Silk-screen designs were produced on the AutoCAD software package and used to produce screens of mesh size 305 for the DEK240 screen-printer.

The carbon ink, Electrodag 423ss (Acheson Colloids Company) was printed using these onto A4 release film CR50 (Rayoweb) on the non-corona treated side. The snap distance, pressure and squeegee hardness on the DEK system will be dependent on the screen design.

These printed sheets were then oven cured at a temperature of 90-degrees centigrade for ninety-minutes and allowed to cool.

These printed sheets are then covered in a protective or sealing layer of methacrylate polymer D2000222D2 (Gwent Electronic Materials) by screen-printing. The sheets are then cured at 50-degrees centigrade for an hour and allowed to cool.

An A4 sheet of 330-micrometre PET with thermoplastic adhesive AS1065 laminated to it (GTS) has its protective layer removed. The printed sheets, described above, are placed with the methacrylate polymer layer facing the adhesive surface. This is then passed through a Photonex-325LSI (Muro) laminator at speed setting 2 (approximately 0.01 m/s) at a temperature of 123-degrees centigrade, making sure that the PET substrate is uppermost in the laminator.

The release film is removed from the product so far and filtered photo-resist HPR504 (Arch Chemicals, Inc.) is dip-coated onto the surface. Silicon wafer sized sections, 3-inch discs, were also cut from the A4 sheet and the resist spun coated onto the discs at 6000 rpm.

The substrate is then baked at 70-degrees centigrade for 15-minutes and the resist patterned using a photo-mask on a Premica Mask Aligner.

This disc is then developed in a PLSI developer (Arch Chemicals, Inc.) and de-ionised water mixture in 1:1 ratio for 1 minute then rinsed clean in water and dried with care.

The microelectrodes can then be cut or pressed out from the disc.

1. A process for preparing a printed substrate which comprises:
(a) printing the desired pattern on to a release film,
(b) adhering a substrate layer to the patterned side of the printed release film substrate, and
(c) removing the release film, thereby producing a substrate bearing a print, the flatness of the surface of which corresponds to that of the film.

2. A process according to claim 1 in which the release film has a thickness of 20 to 175 microns.

3. A process according to claim 1 or 2 in which the release film in an olefinic polymer, a polyester or a polyfluorocarbon.

4. A process according to any one of the preceding claims in which the pattern is applied in step (a) using screen printing.

5. A process according to any one of the preceding claims in which in step (a) screen-printing is carried out with an electrically conductive ink.

6. A process according to claim 7 in which the ink is based on carbon, silver, gold or platinum.

7. A process according to any one of the preceding claims in which after application of the desired pattern in step (a) the film is heated to cure the printed pattern.

8. A process according to any one of the preceding claims wherein step (b) is carried out by (b′) applying a sealing layer over the printed pattern and (b″) contacting the substrate with the patterned side of the printed release film so that the sealing layer adheres to the substrate.

9. A process according to claim 8 in which the substrate is polymeric.

10. A process according to claim 9 in which the substrate is of polyethylene terephthalate, PBT or PVC.

11. A process according to any one of claims 8 to 10 in which, in step (b′), the release film is mounted on a support and the sealing layer is applied by spraying, dip coating or screen-printing.

12. A process according to any one of claims 8 to 11 in which the sealing material is a polyurethane resin or an alkyd resin.

13. A process according to any one of claims 8 to 12 in which, in step (b″), the substrate is brought into contact with the release film by being injection moulded onto the patterned side of the film.

14. A process according to any one of claims 8 to 13 in which an adhesive layer is applied to the substrate to ensure adherence of the sealing layer.

15. A process according to claim 14 in which the adhesive is a thermoplastic adhesive with a softening point of 60° C. to 150° C., a UV-curable adhesive, or an aerobic curing adhesive.

16. A process according to any one of claims 1 to 7 in which in step (b) a polymerisable monomer is applied to patterned side of the printed release film and is then polymerised.

17. A process according to any one of claims 1 to 7 in which in step (b) the substrate is injection moulded over the patterned side of the printed release film.

18. A process according to any one of claims 1 to 7 in which in step (b) an adhesive layer is applied to the patterned side of the printed release film.

19. A process according to any one of the preceding claims in which, after step (c):
(d) a photoresist is applied over the printed surface and is then subjected to imaged light.

20. A modification of a process as claimed in claim 19 in which the photoresist is applied to the release film and subjected to imaged light before step (a).

21. A modification of a process as claimed in claim 19 in which the photoresist is applied to the release film before step (a), step (a) is then carried out and then the assembly is subjected to imaged light.

22. A process according to any one of claims 19 to 21 in which the resulting material is converted into a microelectrode.

23. A process according to claim 1 substantially as hereinbefore described.

24. A printed substrate whenever prepared by a process as claimed in any one of the preceding claims.

25. A microelectrode whenever prepared by a process as claimed in claim 22.
